(19) United States
(12) Patent Application Publication
(10) Pub. No.: US 2019/0260124 A1
(43) Pub. Date: Aug. 22, 2019

(54) Perimeter Control Architecture for Phased Array Antennas and Metasurfaces

(71) Applicant: California Institute of Technology, Pasadena, CA (US)

(72) Inventors: Artur R. Davoyan, Pasadena, CA (US); Harry A. Atwater, Ph.D., South Pasadena, CA (US)

(21) Appl. No.: 16/280,605

(22) Filed: Feb. 20, 2019

Related U.S. Application Data
(60) Provisional application No. 62/632,949, filed on Feb. 20, 2018.

(51) Int. Cl. H01Q 3/36; H01Q 3/22; G01S 13/89; G01S 15/89

(52) U.S. Cl. CPC H01Q 3/36; G01S 15/89; G01S 13/89; H01Q 3/22

(57) ABSTRACT

Perimeter control architectures for phased array antennas and metasurfaces are provided. A plurality of waveform emitters is disposed in an array having a plurality of rows and a plurality of columns. Each of the emitters is disposed within one of the plurality of rows and one of the plurality of columns. A plurality of column control lines is provided, each column control line interconnecting the emitters within one of the plurality of columns and adapted to provide a column control signal to the emitters within that column. A plurality of row control lines is provided, each row control line interconnecting the emitters within one of the plurality of rows and adapted to provide a row signal to the emitters within that row. A phase of each of the plurality of waveform emitters varies with the column control signal and the row control signal provided to that emitter, the plurality of waveform emitters remaining coherent.

### CROSS-REFERENCE TO RELATED APPLICATIONS

This application claims the benefit of Provisional Application No. 62/632,949, filed Feb. 20, 2018, which is hereby incorporated by reference in its entirety.

### BACKGROUND

Embodiments of the present disclosure relate to coherent phase array optics, and more specifically, to perimeter control architectures for phased array antennas and metasurfaces.

### BRIEF SUMMARY

In various embodiments, phased array devices are provided. A plurality of waveform emitters is disposed in an array having a plurality of rows and a plurality of columns. Each of the emitters is disposed within one of the plurality of rows and one of the plurality of columns. The device includes a plurality of column control lines, each column control line interconnecting the emitters within one of the plurality of columns and adapted to provide a column control signal to the emitters within that column. The device includes a plurality of row control lines, each row control line interconnecting the emitters within one of the plurality of rows and adapted to provide a row signal to the emitters within that row. A phase of each of the plurality of waveform emitters varies with the column control signal and the row control signal provided to that emitter, the plurality of waveform emitters remaining coherent.

In various embodiments phased array devices are provided. A plurality of waveform detectors is disposed in an array having a plurality of rows and a plurality of columns, each of the detectors being disposed within one of the plurality of rows and one of the plurality of columns. The device includes a plurality of column control lines, each column control line interconnecting the detectors within one of the plurality of columns and adapted to provide a column control signal to the detectors within that column. The device includes a plurality of row control lines, each row control line interconnecting the detectors within one of the plurality of rows and adapted to provide a row signal to the detectors within that row. A phase of each of the plurality of waveform detectors varies with the column control signal and the row control signal provided to that detectors, the plurality of waveform detectors remaining coherent.

In various embodiments, methods and computer program products for beam steering are provided. A plurality of row signals and a plurality of column signals are provided to an array of waveform emitters. The array has a plurality of rows and a plurality of columns, each of the emitters being disposed within one of the plurality of rows and one of the plurality of columns. Column control signals are provided to the plurality of waveform emitters via a plurality of column control lines, each column control line interconnecting the emitters within one of the plurality of columns. Row control signals are provided to the plurality of waveform emitters via a plurality of row control lines, each row control line interconnecting the emitters within one of the plurality of rows. The phase of each of the plurality of waveform emitters is varied by varying a control signal gradient along the row control lines and column control lines, the plurality of waveform emitters remaining coherent.

In various embodiments, methods and computer program products for holographic image projection are provided. A plurality of row signals and a plurality of column signals are 32244.10201 provided to an array of scatterers. The array has a plurality of rows and a plurality of columns, each of the scatterers being disposed within one of the plurality of rows and one of the plurality of columns. Column control signals are provided to the plurality of scatterers via a plurality of column control lines, each column control line interconnecting the scatterers within one of the plurality of columns. Row control signals are provided to the plurality of scatterers via a plurality of row control lines, each row control line interconnecting the scatterers within one of the plurality of rows. The array is exposed to an incident electromagnetic plane wave. The incident wave is modulated by varying a control signal gradient along the row control lines and column control lines, while maintaining coherence.

### BRIEF DESCRIPTION OF THE SEVERAL VIEWS OF THE DRAWINGS

FIG. 1A is a schematic illustration of a planar array of emitters according to embodiments of the present disclosure.

FIG. 1B is a schematic view of coherent arrays and individual control architectures according to embodiments of the present disclosure.

FIG. 1C is a schematic view of coherent arrays and perimeter control architectures according to embodiments of the present disclosure.

FIG. 2A illustrates exemplary phase and respective control signals applied on the perimeter of an array for exemplary target angles of beaming with respective radiation patterns in the far field according to embodiments of the present disclosure.

FIG. 2B is a schematic illustration of generalized laws of reflection and refraction with coherent phased arrays with perimeter control according to embodiments of the present disclosure.

FIG. 3A illustrates the principles of Fourier holography and its equivalence to metasurface based holography according to embodiments of the present disclosure.

FIG. 3B shows an exemplary original image of an intensity profile of a Hermit-Gaussian mode according to embodiments of the present disclosure.

FIG. 3C shows a holographic reconstruction of the original image with a perimeter controlled architecture according to embodiments of the present disclosure.

FIG. 3D shows a holographic image generated with an unconstrained phase profile according to embodiments of the present disclosure.

FIG. 3E illustrates the application of perimeter controlled holography to encoding of arbitrary complex images according to embodiments of the present disclosure.

FIG. 4A illustrates applications where phased array optical antennas and metasurfaces according to embodiments of the present disclosure are useful.

FIG. 4B is a graph illustrating the number of array elements with the operation distance for two characteristic values of albedo and two wavelengths of operation according to embodiments of the present disclosure.

FIG. 5 is a schematic of an exemplary emitter geometry according to embodiments of the present disclosure.

FIG. 6 is a schematic illustration of an exemplary circuit layout according to embodiments of the present disclosure.

FIG. 7A-D illustrate an example of beam steering by a non-uniform phased array with voltage-varying amplitude according to embodiments of the present disclosure.

FIG. 8 is a schematic view of a perimeter control architecture according to embodiments of the present disclosure.

FIG. 9 illustrates a method of beam steering according to embodiments of the present disclosure.

FIG. 10 illustrates a method of holographic image projection according to embodiments of the present disclosure.

FIG. 11 depicts a computing node according to an embodiment of the present disclosure.

### DETAILED DESCRIPTION

Coherent phase array optics plays an important role in a diverse range of applications from remote sensing and ranging to long-range communications and holography. Highly directional electromagnetic and acoustic beams are generated with the use of phased array control, or more recently with the use of metasurfaces. These structures contain periodic arrays of emitters and/or scatters, each having its own phase and amplitude. Coherent superposition of the field (acoustic or electromagnetic) emitted by the scatterers (which scatter an incident electromagnetic radiation), when specially controlled, enables for forming narrow beams of radiation in desired directions. This technique is useful in a large number of areas including LIDARs, RADARs, and ultrasound imaging.

However, alternative architectures assume individual control (e.g., by an applied voltage) of each of the emitters. While for a small number of elements such approaches may be sufficient, with an increase of the number of array elements, the control becomes complex and power inefficient. For example, a square array with N elements on each side would require N² control voltages. This becomes insurmountably complex for large aperture arrays. For example, an array with 1000 elements per side, such as would be used at optical frequencies, would require 10⁶ control elements.

Accordingly, there is a need for efficient control architectures that can provide fine grained control of a large number of transmission elements.

To address this and other needs in the art, the present disclosure provides for efficient and compact perimeter control architectures that are applicable to tunable beam steering with phased array optics and holography with metasurfaces. Designs described herein significantly reduce the complexity of control architecture, scaling favorably with the number of tunable elements.

Beam forming relies on a fundamental relation of independent phase progression along two orthogonal directions (e.g., x and y) and a constant phase gradient along these directions. In various embodiments, this superposition of phase gradients along orthogonal planes allows implementation of a perimeter control architecture. Voltages supplied along the orthogonal axes on the perimeter of the array superimpose at any given element inside the array. For the case of a linear voltage phase relation, this voltage superposition directly corresponds to phase superposition. Such a control scheme requires only 2N controls for an N×N array. In various embodiments, these architectures may utilize nonlinear gradients and phase relations. Although various exemplary embodiments are described herein, it will be appreciated that the approaches described are applicable to different frequency domains, including optics, infrared, terahertz, microwave, and RF, as well as acoustics.

As noted above, arrays of coherently interacting emitters, such as phased array antennas and metasurfaces, play an important role in a diverse range of applications from laser ranging and sensing to optical communications and holography. Hence, phased array optical networks—optical counterparts of RF antenna arrays—offer compact and efficient solutions for LIDARs, which are utilized extensively in autonomous vehicles, and for remote sensing for topography mapping and navigation. Furthermore, coherent optical systems are promising candidates for in-space communications between satellites and as high capacity deep space links. Metasurfaces find application in holography and ultrathin optics that may substitute for conventional bulky systems, such as lenses and spectrometers. High frequency millimeter wave antenna arrays may be applied in ubiquitous and distributed telecommunication networks in the context of Internet of Things and forthcoming communication standards.

Challenge in phase coherent optical systems include emergent phenomena associated with the very large scale of array integration. For example, a near infrared system with wavelength of the order of 1 micron (λ≅1 μm) and with a millimeter size aperture necessitates approximately a million radiators (as described further below), all of which would have to interfere coherently to produce a desired far-field radiation pattern. While design and fabrication of very large passive arrays is possible, their full potential requires tunable control of each and every individual emitter. Hence, tuning the phase and/or amplitude of array elements allows a broad range of functions from holographic displays to beam steering and forming. However, with millions of elements, simultaneous and independent addressing of each element of the array represents an insurmountable task for alternative approaches. To address this problem, perimeter control architectures described herein simplify substantially the complexity of the control architecture, resulting in a reduced number of control signals needed. This approach is well suited for beam steering applications, phase gradient optics, and applications in holography.

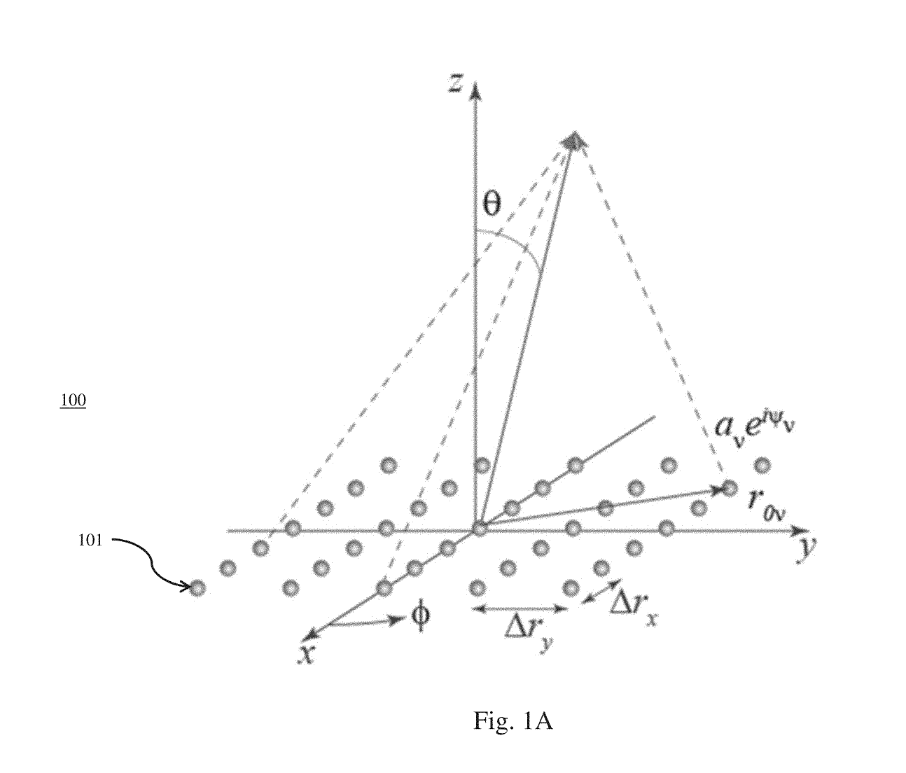

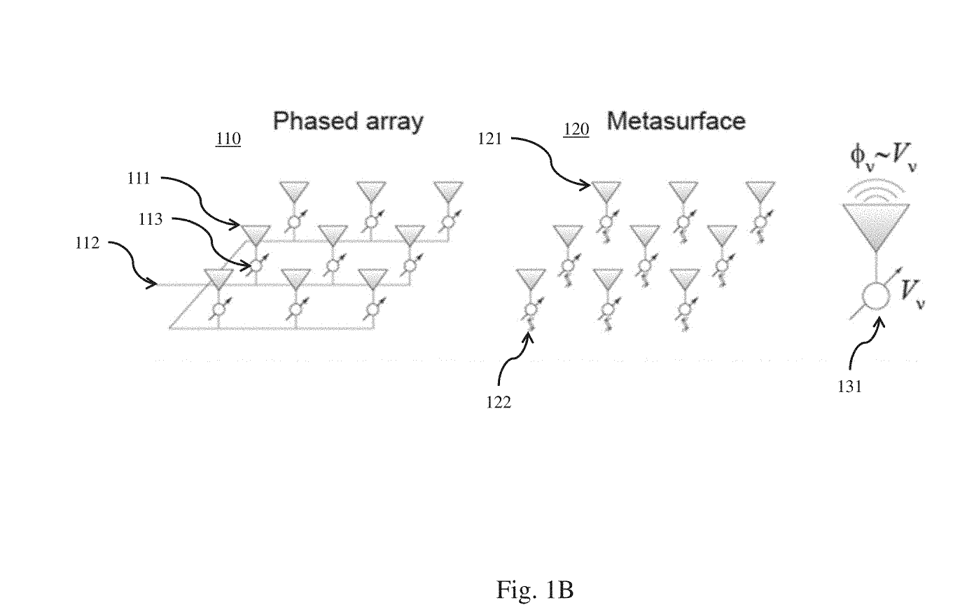

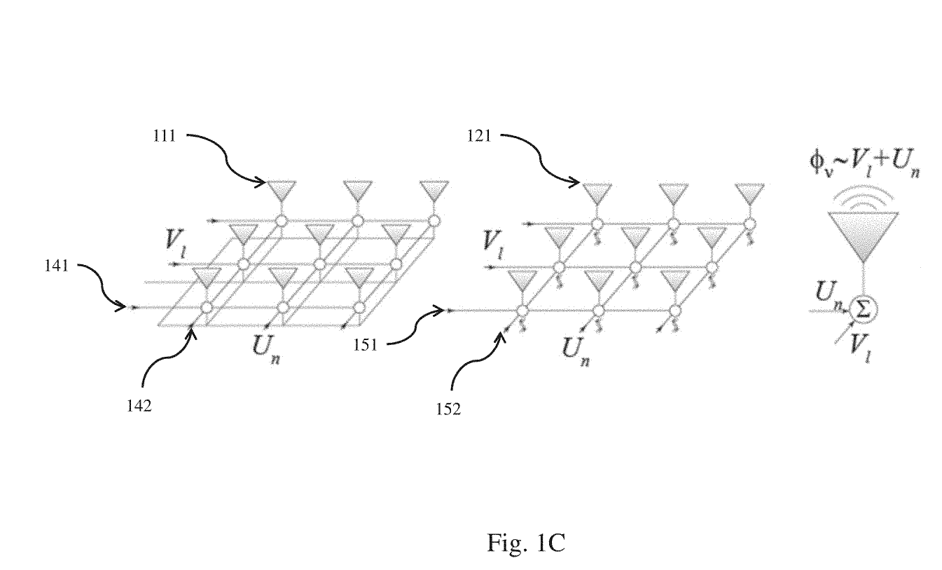

Referring now to FIG. 1, the principles of perimeter control architecture are illustrated.

Consider a general scenario of radiation by an array of electrically small emitters, e.g., antennas in the case of phased array structures or scatterers in the case of metasurfaces. The radiated/scattered field in the far radiation zone of the array is given by a coherent superposition of the fields of the elementary sources with amplitudes aᵥ, and phases ψᵥ located at points r₀ᵥ, as shown in Equation 1, where it is assumed that kr→∞ and r »r₀ᵥ, that is, the distance to the observation point r is much larger than any physical dimension of the array,

$$k = \frac{2 π}{λ}$$

is a free space wavevector, and E is the electric field at the point of observation.

$$E = {\sum }_{v} {e}^{- {ikr}_{0 v}} {a}_{v} {e}^{i {ψ}_{v}} \qquad Equation 1$$

This is illustrated in FIG. 1A, which provides a schematic illustration of a planar array 100 of emitters 101, which may be either individual antennas interfering coherently, or metasurface elements that scatter light to coherently produce desired pattern in the far radiation zone.

According to Equation 1, the far zone radiation pattern is formed due to an interplay of two factors—array geometry, described by the factor e^{-ikr}^{ₒᵥ}, and the intrinsic properties of the scatterer given by its complex amplitude aᵥe^{iψ}^{ᵥ}. Below, without loss of generality, a square array with N×N uniformly spaced elements is assumed (as pictured in FIG. 1A). It will be appreciated that concepts and principles described herein are applicable in the context of rectangular arrays, and furthermore may be extended to other array topologies, including circular and hexagonal arrays.

For a uniform spacing of array elements the geometric phase krₒ, factorizes into krₒ, =k(lΔrₓ sin(θ) cos(ϕ)), where Δrₓ and Δr_{y} denote distances between array elements along x and y directions, and l and n enumerate array columns (discrete x coordinate) and rows (discrete y coordinate), respectively; θ and ϕ are azimuth and polar angles in the direction of observation (as illustrated in FIG. 1A). The radiated far field is then rewritten as in Equation 2.

$$E = {\sum }_{l} {\sum }_{n} {a}_{l n} {e}^{i {ψ}_{l n}} exp ( - i k l Δ {r}_{x} sin ( θ ) cos ( φ ) - i k n Δ {r}_{y} sin ( θ ) sin ( φ ) ) \qquad Equation 2$$

Referring to FIG. 1B, types of coherent arrays and individual control architectures are illustrated. In phased arrays antenna 110, elements 111 are fed with a common source 112 that is then distributed through a control network of phase shifters 113. Metasurface 120 elements 121, in contrast are excited in parallel with an incident wave 122. In both of these cases, individual control architectures assume that the phase of each element is tuned independently of its neighbors, requiring N² controls 131.

In a most general scenario of a tunable system each of the array elements is controlled by some applied signal Vᵥ, which may correspond to an applied voltage, temperature, or a magnetic field. Physically, the tunability of an individual array element is obtained by modifying its local properties with an applied control signal. For example, a locally applied electric field may change the dielectric permittivity or permeability of the material in a number of ways, including charge carrier redistribution, electro-absorption modulation, Pockels effect, and other effects. Local temperature gradient, in turn, may lead to local gradient in the refractive index due to thermo-optical material responses. An applied magnetic field might induce magneto-optical change of local refractive index and hence modify the properties of the emitter. Similar applied forces may modify not only electromagnetic properties, but also acoustic ones, which may be utilized for controlling coherent acoustic systems, as discussed below. An applied signal modifies local properties of the v-th emitter so that both its amplitude and phase may vary, aᵥ=aᵢₙ(Vᵢₙ) and ψᵥ=ψₗₙ(Vₗₙ) ≡F(Vₗₙ). Such a general scenario of simultaneously and independently controlled array elements would require N×N of control signals. As the number of array elements grows the control of the entire array encounters significant technical challenges.

Referring to FIG. 1C, a schematic illustration is provided of a perimeter control architecture according to embodiments of the present disclosure. The phase of each of the array elements 111, 121 is defined by the superposition of control signals applied to respective rows 141, 151 and columns 142, 152 of the array. The total number of controls is 2N.

The perimeter control architecture depicted in FIG. 1C reduces the complexity and decreases the number of control signals needed relative to the exemplary architecture depicted in FIG. 1B. Specifically, control signals are applied not to individual elements of the array, but rather to each row and column of the array. In this case, the control signal at the v-th element of the array is a function of control signals applied to respective column l and row n, Vᵥ=f (Vₗ+Uₙ); Vₗ and Uₙ denote control signals along x and y directions of the array, respectively.

For the sake of simplicity of explanation, it is assumed that the array contains equivalent elements and that the amplitude of each element is not varied with an applied control signal, that is, aᵥ=a≡const (this assumption is further discussed below). The phase, however, varies and can be expressed as ψᵥ(Vᵥ)≡F(Vᵥ)═F[f (Vₗ+Uₙ)]. For a monotonic dependence of phase on an applied control signal (which is typically obtained in experiments), it may be required that F[f (Vₗ+Uₙ)]=Vₗ+Uₙ, i.e., f(·)=F⁻¹(·). In this case, the array radiation in the far field is given simply as E(θ, ϕ)=aAFₚₑᵣᵢₘ (θ, ϕ), where Equation 3 is the array factor of the perimeter controlled phased array.

$${AF}_{perim} ( θ , φ ) = {\sum }_{l} {\sum }_{n} exp ( {iV}_{l} + {iU}_{n} ) exp ( - i k l Δ {r}_{x} sin ( θ ) cos ( φ ) - i k n Δ {r}_{y} sin ( θ ) sin ( φ ) ) \qquad Equation 3$$

This expression may be written in a compact matrix form as in Equation 4, where ⊗ denotes an outer product between two linearly independent vectors νₗ=exp[iVₗ−iklΔrₓ sin(θ)cos(ϕ)] and uₙ=exp[iUₙ−iknΔr_{y} sin(θ) sin(ϕ)] associated with the columns and rows of the array, and |e [symbol] =(1, . . . , 1, . . . , 1) is a unitary vector. Hence, the far field of such an array is given as a convolution of two linearly independent responses associated with the orthogonal directions of the array.

AFₚₑᵣᵢₘ(θ, ϕ)= [symbol] e|v⊗u|e [symbol] Equation 4

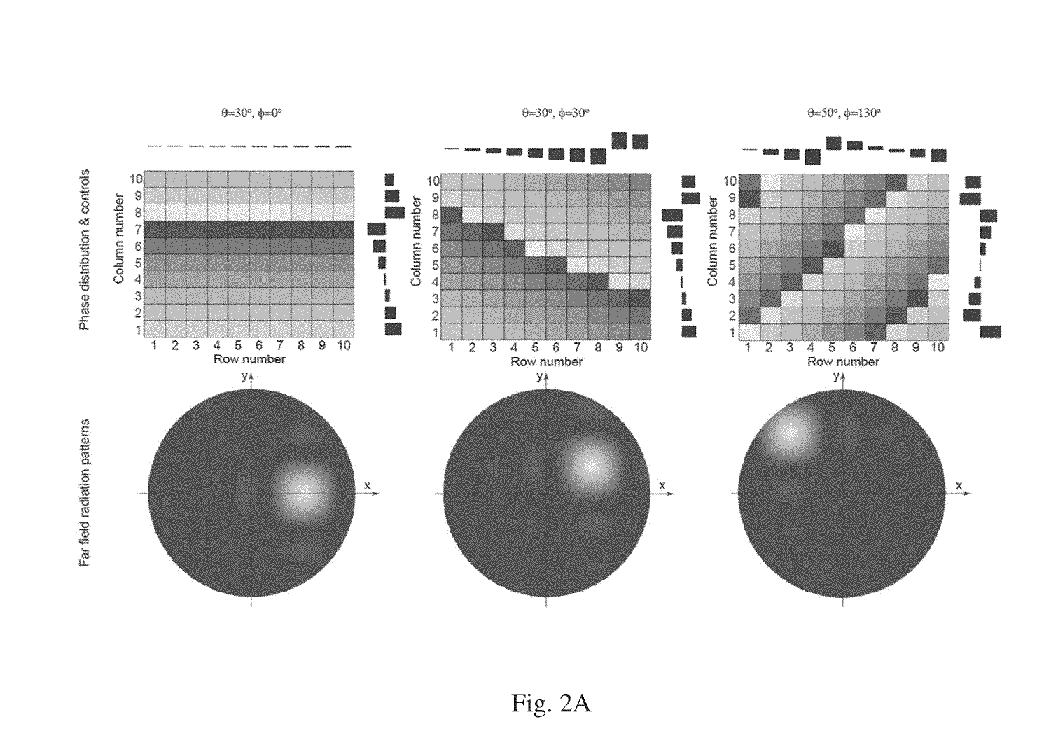

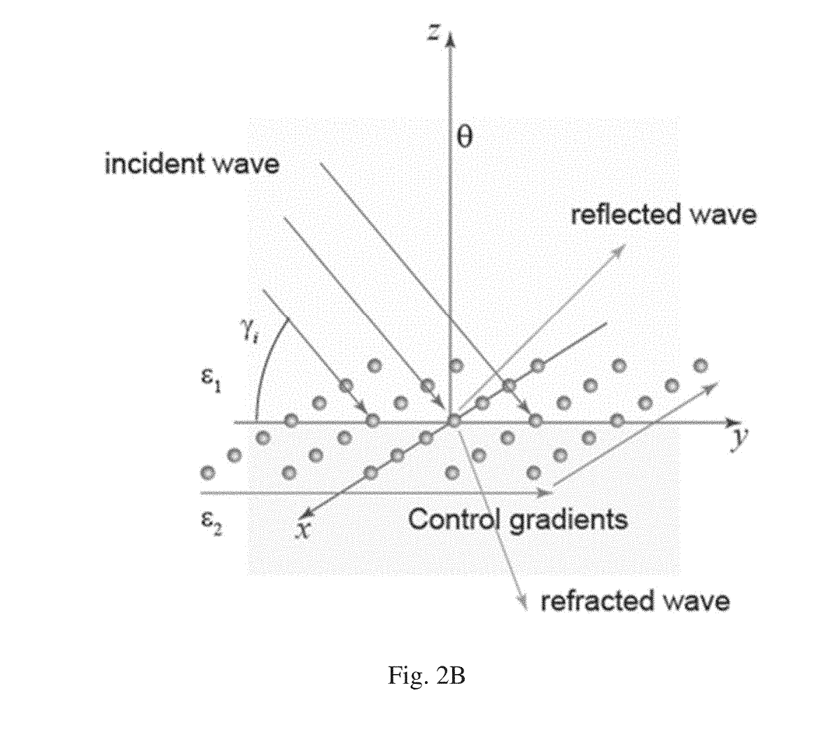

Referring now to FIG. 2, beam steering and generalized Snell's laws are illustrated. In FIG. 2A, the top row shows distribution of phase and respective control signals applied on the perimeter of a 10×10 array for several target angles of beaming. The bottom row shows respective radiation patterns in the far field. FIG. 2B is a schematic illustration of a generalized laws of reflection and refraction with coherent phased arrays. A plane wave is incident at an angle yᵢ on an planar array located at the interface of two media with permittivities ε₁ and ε₂, respectively. For small spacing between array elements and upon application of control signal gradient on the perimeter of the array, scattered reflected and refracted fields beyond conventional Snell's law are induced.

In beam forming and steering, phases of the individual elements of the array are superimposed coherently to form a narrow pencil beam. The direction of emission may be controlled by tailoring phase gradient. The performance of such an array is determined by the phase distribution across the entire system (the array factor). For a uniform planar array with equidistant spacing of array elements, and for a linear phase gradient between the array elements, the array factor of a pencil beam is given in Equation 5.

$${AF}_{pencil} ( θ , φ ) = {\sum }_{l} exp il [ Δ {ψ}_{x} - \frac{2 π}{λ} Δ {r}_{x} sin ( θ ) cos ( φ ) ] {\sum }_{n} exp i n [ Δ {ψ}_{y} - Δ {r}_{y} \frac{2 π}{λ} sin ( θ ) sin ( φ ) ] ℌ \qquad Equation 5$$

Comparing Equation 5 with an expression for the array factor of the perimeter controlled architecture (Equation 3) it is shown that AFₚₑᵣᵢₘ(θ, ϕ)≡AF_{pencil}(θ, ϕ) when ψᵥ(V^{v})≡Vₗ+Uₙ=lΔψₓ+nΔψ_{y}. This relation holds for Vₗ=lΔψₓ and Uₙ=nΔψ_{y}. Therefore, choosing linear gradients of the signal on the perimeter of the array reproduces the full functionality of beam steering for arrays with individually controlled elements. For a linear gradient of phase (or control signal) the array factor convolves into a compact expression as in Equation 6, where

$${δ}_{x} = Δ {ψ}_{x} - \frac{2 π}{λ} Δ {r}_{x}$$

sin(θ)cos(ϕ) and

$${δ}_{y} = {Δψ}_{y} - \frac{2 π}{λ} Δ {r}_{y}$$

sin(θ)sin(ϕ) are respective array phase factors along x and y directions.

$$AF ( θ , φ ) = \frac{sin ( \frac{N {δ}_{x}}{2} ) sin ( \frac{N {δ}_{y}}{2} )}{sin ( \frac{ {δ}_{x}}{2} ) sin ( \frac{ {δ}_{y}}{2} )} \qquad Equation 6$$

For a desired direction of the pencil beam θ₀ and ϕ₀ (the direction of the main radiation lobe) one may find the phase gradient, and hence, corresponding signal gradient, required. The direction of the beam is found from condition δₓ=δ_{y}=0 and yields

$$Δ {ψ}_{x} = \frac{2 π}{λ} Δ {r}_{x}$$

sin(θ₀) cos(ϕ₀) and

$${Δψ}_{y} = \frac{2 π}{λ} Δ {r}_{y}$$

sin(θ₀)sin(ϕ₀). FIG. 2A shows several examples of perimeter controlled beam steering. To avoid the grating lobes, the column and row spacing between the array elements should be less than the wavelength. The beam width between two adjacent nulls along x and y axis can be found as

$$Δ {β}_{x} ≃ \frac{2 λ}{Δ {r}_{x} N} and Δ {β}_{y} ≃ \frac{2 λ}{Δ {r}_{y} N} ,$$

respectively.

Consider a case of a metasurface excited with an obliquely incident plane wave. Consider, without loss of generality a plane wave incident at some angle yᵢ in the (x, z) plane on an infinitesimally thin metasurface located at the interface of two media with permittivities ε₁ and ε₂, respectively (as shown in FIG. 2B). It is assumed an array with a finite aperture Rₓ×R_{y}=NΔrₓ×NΔr_{y}. The oblique incidence will induce an additional phase delay between excited metasurface elements Δψₓ^{inc}=k\sqrt{ε₁} sin(yᵢ) Δrₓ (assuming that the wave is incident from a medium with permittivity ε₁). The radiation pattern of the array in the i-th medium is again defined by the array factor (Equation 6), however with a modified array phase factors δₓ=Δψₓ+Δψₓ^{inc}−k\sqrt{εᵢ}Δrₓ sin (θ)cos(ϕ) and δ_{y}=Δψ_{y}−k\sqrt{εᵢ}Δrₓ sin(θ)sin(ϕ), where εᵢ=ε₁ for radiation pattern above the metasurface (reflected beam) and εᵢ=ε₁ for radiation below metasurface (refracted beam).

The array phase factors are determined by three contributions, including the oblique incidence (k\sqrt{ε₁} sin(γᵢ)Δrₓ), intrinsic phase gradient of the metasurface (Δψₓ) and the gradient due to array geometry (−k\sqrt{εᵢ}Δrₓ sin(θ)cos(ϕ)). The direction of the main lobe is again found from condition δₓ=δ_{y}=δ0. For given metasurface phase gradients Δψₓ and Δψ_{y} and incidence angle γᵢ Equation 7 determine the direction of emission.

$$\sqrt{{ɛ}_{i}} sin ( θ ) cos ( φ ) = \sqrt{{ɛ}_{i}} sin ( {γ}_{i} ) + \frac{{Δψ}_{x}}{Δ {r}_{x}} \\ \sqrt{{ɛ}_{i}} sin ( θ ) sin ( φ ) = \frac{{Δψ}_{y}}{Δ {r}_{y}} \qquad Equation 7$$

In the limit of Δrₓ→0 and Δr_{y}→0 expressions similar to generalized Snell's laws of reflection and refraction are obtained, defined by phase gradients in x and y direction

$$\frac{\partial {ψ}_{x}}{\partial x} and \frac{\partial {ψ}_{y}}{\partial y} ,$$

respectively. In perimeter controlled architectures as described herein, the phase increments Δψₓ and Δψ_{y} are linearly related to signals Vₗ and Uₙ applied on the perimeter of the array. Hence, this approach allows for fully controlling radiation emission in this case. A finite aperture size is assumed here, hence the generated fields are regular pencil beams with divergence angles defined as:

$$Δ {β}_{x} ≃ \frac{2}{\sqrt{{ɛ}_{i}}} \frac{λ}{{R}_{x}} and Δ {β}_{y} ≃ \frac{2}{\sqrt{{ɛ}_{i}}} \frac{λ}{{R}_{y}} .$$

For an infinite aperture size, as Rₓ→∞ and R_{y}→∞, the approximations used to develop array theory are not applicable, as an assumption r>>R_{x,y} does not hold any more. In this case, it is possible to show that radiated fields of such an infinite array are familiar reflected and refracted plane waves, E˜exp[∓ik\sqrt{εᵢ}(sin(θ)cos(ϕ)×+sin(θ)sin(ϕ)y+cos(θ)z)], where angles θ and ϕ are selected according to Equation 7. Hence, actual generalized Snell's laws are recovered in this limit (the corresponding analysis is omitted for clarity of discussion).

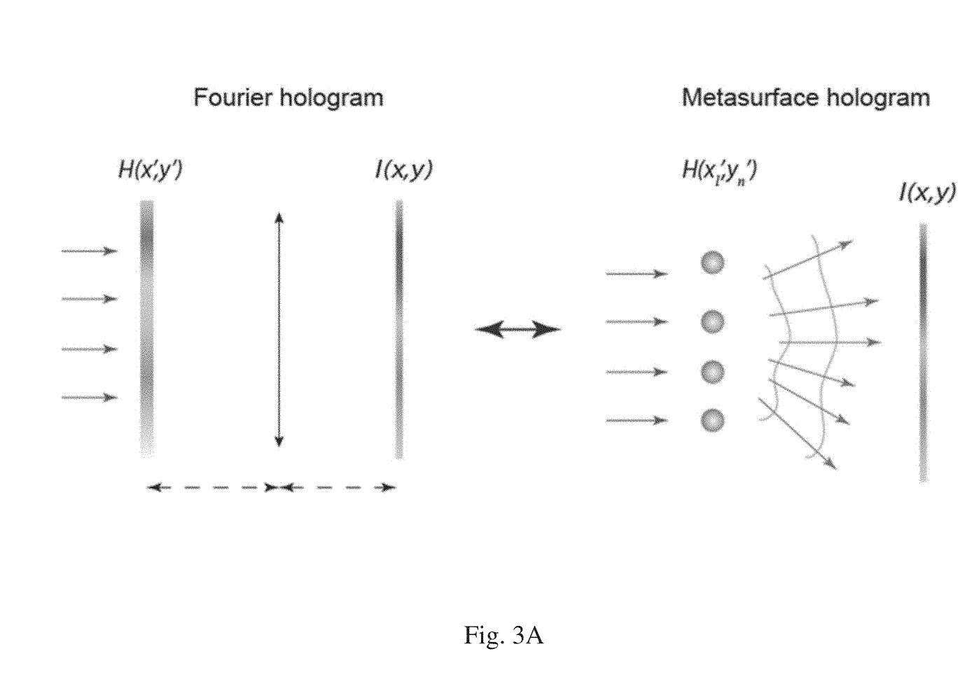

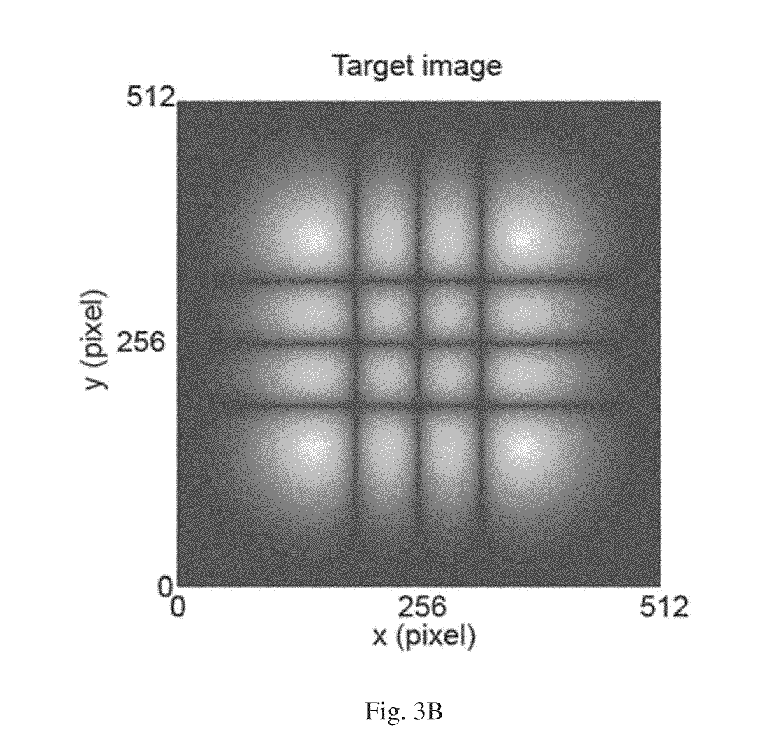

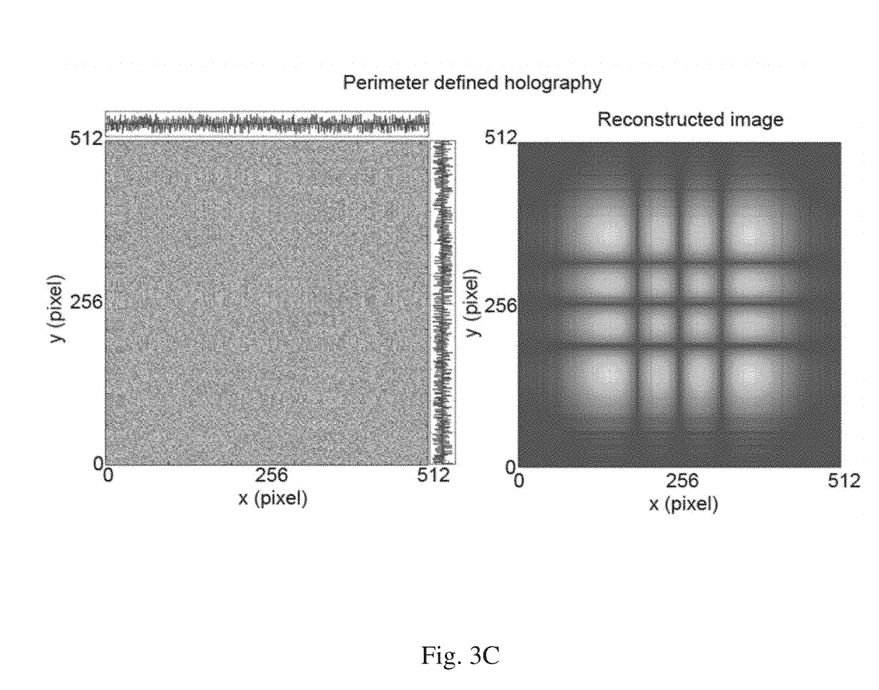

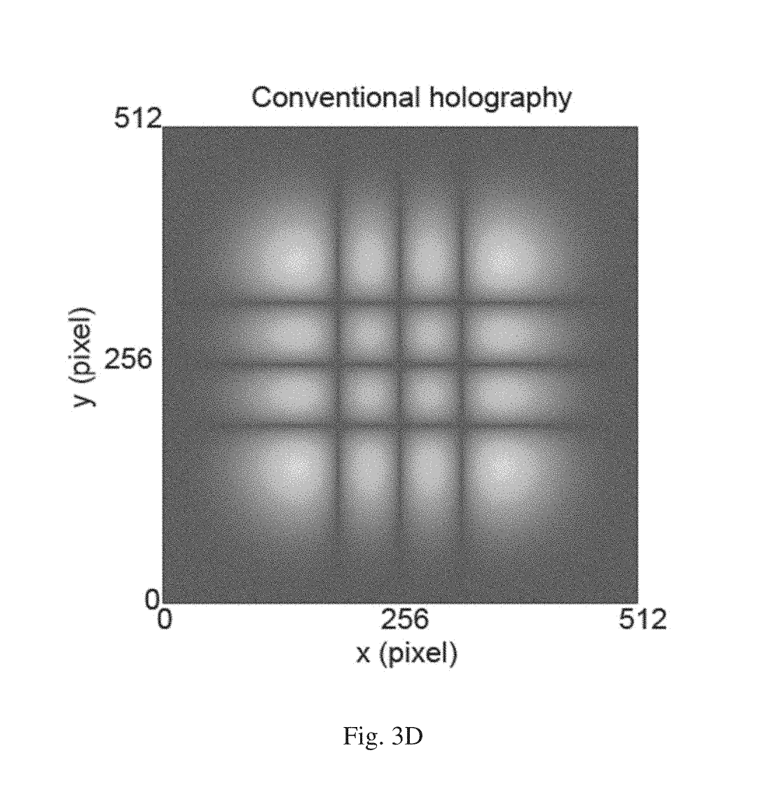

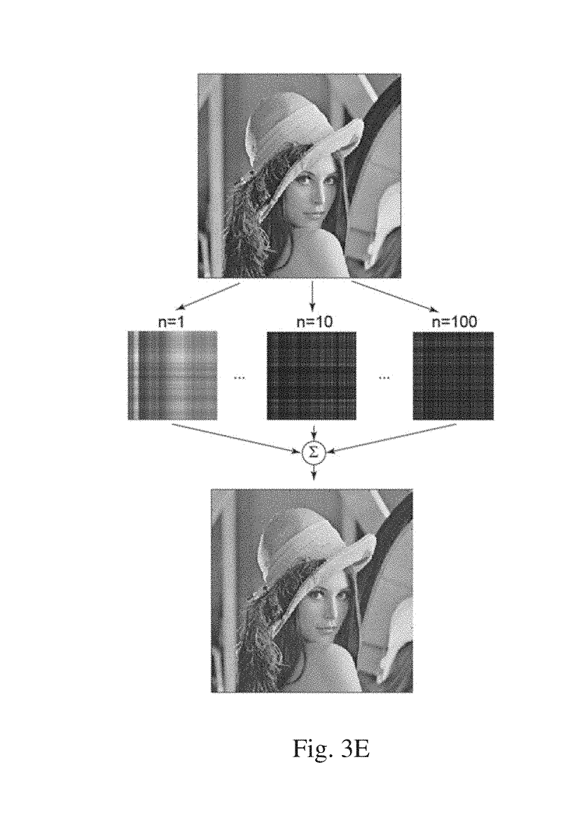

Referring now to FIG. 3, principles of perimeter controlled holography are illustrated. FIG. 3A illustrates the principles of Fourier holography and its equivalence to metasurface based holography. FIG. 3B shows an original 512×512 pixel image of a (3,3) Hermit-Gaussian mode. FIG. 3C shows a holographic reconstruction of the original image with a perimeter controlled architecture. The left panel shows a phase distribution across the phased array together with control signals applied to its rows and columns. The right panel shows a reconstructed image. A holographic image generated with an unconstrained phase profile (where the phase of each element may be tuned independently) is shown for comparison in FIG. 3D. FIG. 3E illustrates the application of perimeter controlled holography to encoding of complex images. Full holographic image may be represented as a sum of simple images defined by a set of separable matrixes, each of which can be encoded as set out herein. Several of these elementary images are shown here.

Holography is another class of applications where metasurfaces and phased arrays are useful. In phase-only holograms (also known as kinoforms), a desired image is reconstructed as a Fourier transform of a holographic phase-only mask Hₚₕₐₛₑ(x′, y′)≡e^{iψ(x′,y′)}, i.e., l(x, y)≃ [symbol] _{2D}(e^{iψ(x′,y′)}), where l(x, y) denotes a complex field amplitude in the image plane (x, y) and [symbol] _{2D}(·) is a 2D Fourier transform acting in the (x′, y′) plane of the hologram (as shown in FIG. 3A). A computer generated algorithm is then applied to produce a discretized phase profile that samples the holographic mask: e^{iψ(x′,y′)}≃Σ_{l,n}e^{iψ(x′}^{ₗ}^{,y′}^{ₙ}⁾δ(x′−x′ₗ, y′−y′ₙ), here δ(·) denotes Dirac delta function. The reconstructed image is hence well approximated by a discrete 2D Fourier transform (DFT) of the discretized phase mask as shown in Equation 8, where l, n and p, q enumerate corresponding rows and columns in the holographic mask plane and reconstructed image plane, respectively.

$$I ( x , y ) ≃ {\sum }_{l , n} {e}^{i ψ ( {x}_{l}^{′} , {y}_{n}^{′} )} {e}^{- ik ( \frac{x}{z} {x}_{l}^{′} + \frac{y}{z} {y}_{n}^{′} )} ≃ {DFT}_{2 D} [ {e}^{i ψ ( {x}_{l}^{′} , {y}_{n}^{′} )} ] = I ( {x}_{p} , {y}_{q} ) \qquad Equation 8$$

$$Recognizing that k sin ( θ ) cos ( φ ) = {k}_{x} = k \frac{x}{z} and k sin ( θ ) sin ( φ ) = {k}_{y} = k \frac{y}{z} in expression$$

Equation 3, it may be shown that an array factor of a metasurface or of an equivalent antenna array with a properly chosen phase distribution ψ_{l,n} describes a desired discretized holographic mask. In case of a perimeter control architecture, the phase ψ_{l,n} of the element in the l-th row and n-th column is given by superposition of control signals Vₗ and Uₙ applied to respective columns and rows of the array. The array factor in this case may be represented as in Equation 9.

AFₚₑᵣᵢₘ(θ, ϕ)≃DFT_{2D}[exp(iVₗ+iUₙ)]=DFT_{2D}[e^{iV}^{ₗ}⊗e^{iU}^{ₙ}]=l(xₚ,y_{q}) Equation 9

Hence, in a perimeter controlled architecture any phase mask given as an outer product of two linearly independent orthogonal vectors may be generated, Hₚₕₐₛₑ(xₗ,′ y′ₙ)=e^{iV}^{ₗ}⊗e^{iU}^{ₙ}. Furthermore, since discrete Fourier transform is a linear operation, the reconstructed image may also be described as a product of two linearly independent functions f (xₚ) and g (y_{q}), l(xₚ, y_{q})=f(xₚ)⊗g(y_{q}). Therefore a class of holograms described by separable matrices may be encoded as described herein. One of the prominent examples are Hermit-Gaussian beams for which the scalar electric field at waist is given as

$$E ( x , y ) = {H}_{{v}_{x}} ( \frac{\sqrt{2} x}{{w}_{0}} ) {e}^{- \frac{{x}^{2}}{{w}_{0}^{2}}} {H}_{{v}_{y}} ( \frac{\sqrt{2} y}{{w}_{0}} ) {e}^{- \frac{{y}^{2}}{{w}_{0}^{2}}} ,$$

where Hᵥ are v-th order Hermit polynomials and w₀ is the beam waist. FIGS. 3B-D show an example of holographic generation of Hermite-Gaussian beams with the use of the techniques described herein (an iterative Fourier transform algorithm is used to find the required phase mask, e^{iV}^{ₗ} ⊗e^{iU}^{ₙ}). As demonstrated, the original image is fully reconstructed.

Any complex image approximated by an N×N matrix l(x, y)≃l(xₚ,y_{q}) with rank ≤N with the use of a singular value decomposition may be represented as a sum of separable matrixes: l(xₚ, y_{q})=ΘⱼÂⱼ=Θⱼσⱼuⱼ⊗vⱼ, where uⱼ and vⱼ are the j-th columns of the corresponding singular value decomposed matrices, σⱼ are the ordered singular values. These methods enable encoding each of the Âⱼ matrixes. In most of the practical cases only j=1 . . . M (M<N) of matrixes contribute to the formation of an image.

For comparison, in raster scanning, an image is formed through N×N consecutive time steps (pixel by pixel imaging). In contrast, the methods described herein allow significant simplification of the number of steps needed to form an image, as at most only M <<N² consecutive steps are needed. FIG. 3E illustrates this approach.

In various example herein, control signals applied to metasurface and antenna array elements modify the relative phase of the emitters, while emitter amplitude is assumed to stay constant. In practice, amplitude and phase variation may not be completely decoupled. That is, one may expect that amplitude is not constant, but varies with an applied signal. It will be appreciated that although the mathematical descriptions provided above make this assumption, the perimeter controlled architectures provided herein may still be applied with the use of optimization techniques.

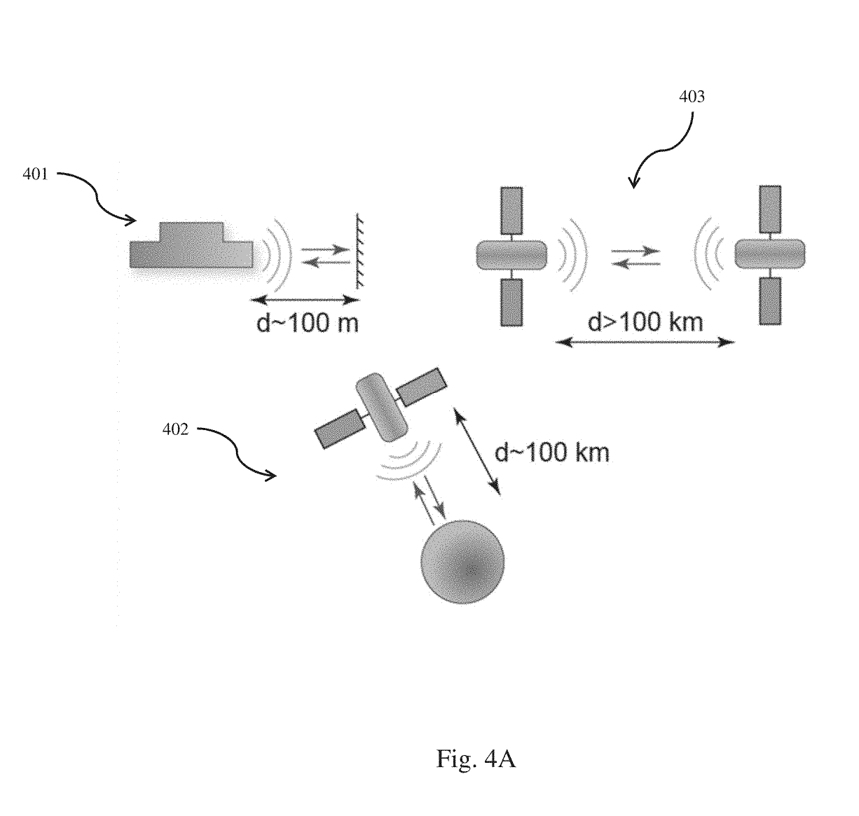

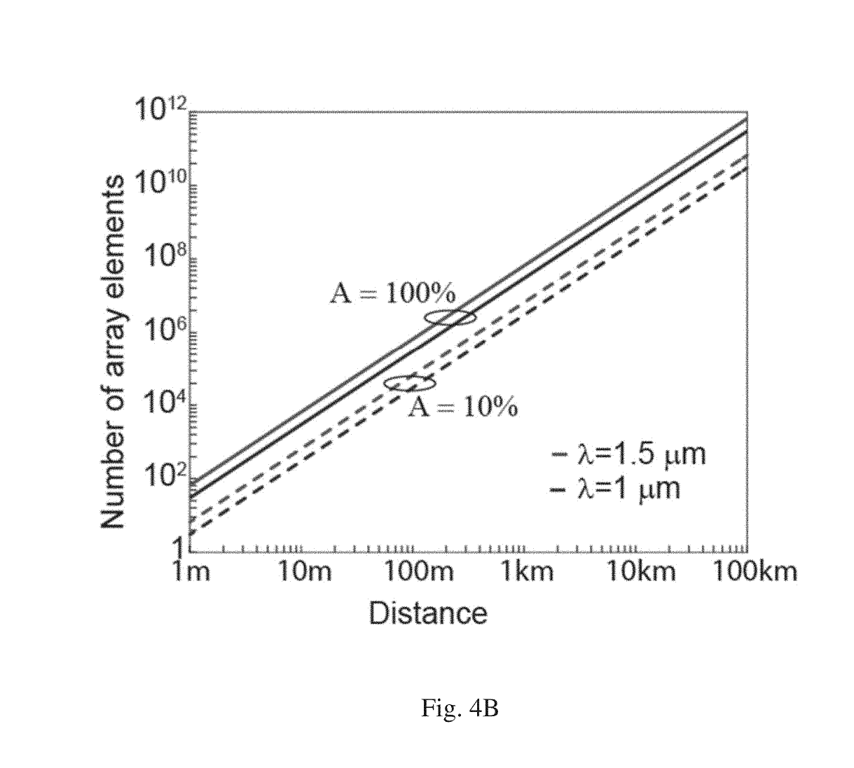

Referring to FIG. 4, array element number scaling laws for coherent phase optical systems are illustrated. FIG. 4A illustrates several typical applications where phased array optical antennas and metasurfaces may be of a particular use, including LIDARs and space communications. Expected operation distances are shown schematically. FIG. 4B is a graph illustrating the number of array elements with the operation distance for two characteristic values of albedo and two wavelengths of operation.

Optical phased arrays are useful in a variety of area, including long range operation such as 100 m for LIDARs on autonomous vehicles 401 to over 100 km for space based remote sensing 402 and inter-satellite communication systems 403. Consider a square planar antenna array with N×N elements (as shown schematically in FIG. 1A) with elements spaced

$$\frac{λ}{2}$$

away from each other. The number N can be estimated that is needed for such long range operation distances. The transmitter and receiver are considered to have similar antenna gain factors, G˜πN². Using Friis transmission formula, the number of antenna elements needed can be estimated as in Equation 10, where d is the distance between the transceiver and the receiver, λ is the operation wavelength, P is the power transmitted, and Pₘᵢₙ is the minimum detectable signal at the receiver side.

$$G = π {N}^{2} = 4 π \frac{d}{λ} \sqrt{\frac{{P}_{m i n}}{P}} \qquad Equation 10$$

To analyze this expression further, it is convenient to express the detectable signal power through a signal to noise ratio, Pₘᵢₙ=Pₙₒᵢₛₑδ, where Pₙₒᵢₛₑ is the noise power level and δ is the required signal to noise ratio. One of the key noise factors for such optical systems is the ambient solar radiation and albedo of the surroundings. Noise signal is expressed as

$${P}_{noise} = {I}_{ambient} {{N}^{2} ( \frac{λ}{2} )}^{2} ,$$

l_{ambient}≃Alₛₒₗₐᵣ(λ)Δλ, where A is the albedo, lₛₒₗₐᵣ(λ) is the solar flux at wavelength λ and Δλ is the laser bandwidth. The signal to noise ration δ may be estimated from Shannon's limit theorem as

$$δ = {( \frac{η Δ λ}{{λ}^{2}} c )}^{2} - 1 ,$$

where η is the desired acquisition rate for a LIDAR system, or a channel data rate for a communication system, and c is the speed of light.

Combining all of these expressions together gives Equation 11.

$${N}^{2} ≃ 4 \frac{{AI}_{solar} ( λ ) Δ λ}{P} [ {( \frac{η Δ λ}{{λ}^{2}} c )}^{2} - 1 ] d \qquad Equation 11$$

In FIG. 4B, the scaling law is plotted for the number of the array elements (N²) with the operation distance d for some characteristic parameters. Specifically, AM1.5 solar flux, Δλ=1 nm of laser bandwidth, η=1 GHz, and P=1 W are assumed. For these parameters, the signal to noise ratio is δ˜8. According to this estimate, it is shown that for 100 m of operation distance, an array with 10⁴−10⁶ elements is needed, whereas for long range space systems, 10¹⁰˜10¹² of phase tunable antenna array elements are required. Despite a seemingly large number of elements, the characteristic aperture size is physically rather small: ˜1 mm and ˜10 cm, respectively. Thus, addressing each and every element of the array individually represents a substantial challenge.

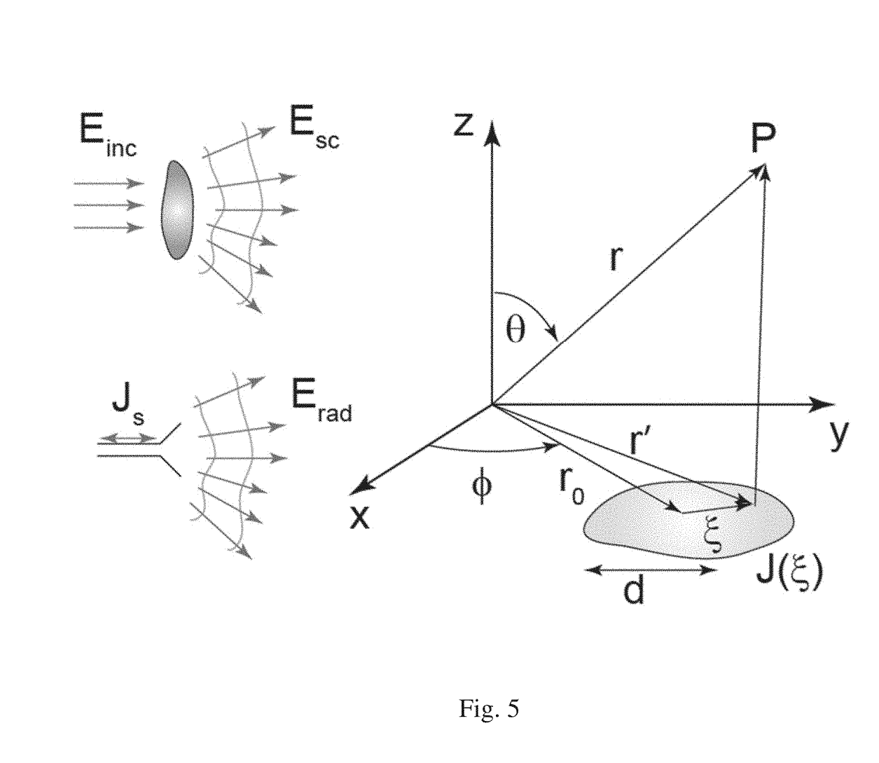

With reference to FIG. 5, a schematic is provided of an exemplary emitter geometry, providing an overview of key notions of radiation theory and its connection to phased array antennas, metasurfaces and diffraction theory. The difference between antenna and scatterer is also shown.

Consider radiation properties of an individual source element, as shown schematically in FIG. 5. Such a source may be an element of an antenna array, a scatterer element of a metasurface, or an element of a diffractive optical system (e.g., hologram or phase grating). Without loss of generality, the properties of a source may be described by a current J(r′)=J_{source}(r′) in case of an antenna fed locally, or J(r′)=−iω(D(r′)−ε₀εE) in the case of a scatterer, where the current is due to the polarization density induced in the scatterer by an incident field E _{inc}. The radiated field in the far zone (for kr→∞, where k is the free space wavevector in the direction of the observation point P) may be expressed with the use of a magnetic vector potential field A(r) as in

Equation 12 where μₒ is the free space permeability, integration is over the volume of the source J(r′), and r′ is the radius vector of the source.

$$A ( r ) = \frac{{μ}_{0}}{4 π} {lim}_{kr \to ∞} \int J ( {r}^{′} ) \frac{{e}^{ik \vert r - {r}^{′} \vert}}{\vert r - {r}^{′} \vert} {d}^{3} {r}^{′} = \frac{{μ}_{0}}{4 π} \frac{{e}^{ikr}}{r} \int J ( {r}^{′} ) {e}^{- {ikr}^{′}} {d}^{3} {r}^{′} , \qquad Equation 12$$

A common approximation is used that assumes that |r−r′| and e^{ik|r-r′|}≃e^{ikr}e^{-ikr′}, physically corresponding to the case of observation distances much larger than the dimensions of an optical system. It is convenient to rewrite the above expression with respect to the center of the source r₀=r′−ξ as in Equation 13.

$$A ( r ) = \frac{{μ}_{0}}{4 π} \frac{{e}^{ikr}}{r} {e}^{- {ikr}_{0}} \int J ( ξ ) {e}^{- ik ξ} {d}^{3} ξ \qquad Equation 13$$

In the limit of a source smaller than the wavelength, when d≤λ, the integrand may be expanded into a series with first order responses given by excited dipole moments (we neglect the contribution of an electric quadrupole here) as in Equation 14, where

$$p = \frac{1}{i ω} \int ξ ∇ J ( ξ ) {d}^{3} ξ and m = \frac{1}{2} \int [ ξ \times J ( ξ ) ] {d}^{3} ξ$$

are electric and magnetic dipole moments, respectively.

$$A ( r ) = \frac{{μ}_{0}}{4 π} \frac{{e}^{ikr}}{r} {e}^{- {ikr}_{0}} ( - i ω p + i [ k \times m ] ) \qquad Equation 14$$

For a case of a metasurface consisting of small scatters, these dipole moments may be expressed as p=a̅ₑE_{inc} and m=a̅ₘE_{inc}, where a̅ₑ and a̅ₘ are respective electric and magnetic polarizability tensors.

The electric field at point r is then found as

$$E ( r ) = \frac{ic}{k} ∇ \times ∇ \times A ( r )$$

and in the limit kr→∞ and r >>r₀ it is given as in Equation 15.

$$E ( r ) = {e}^{- {ikr}_{0}} [ ( \frac{km}{c} + [ k \times p ] ) \times k ] \frac{{e}^{ikr}}{4 π {ɛ}_{0} r} \qquad Equation 15$$

In the case of a scatterer, E denotes the scattered field E=E_{sc}, and the total field is given as a superposition of the incident wave and the scattered wave, Eₜₒₜₐₗ=E+E_{inc}. In Equation 15, the first term is associated with the location of the source and corresponds to the geometric phase delay, whereas the term in the parentheses denotes the intrinsic radiation properties of the source, commonly denoted as an antenna factor in the context of phased array antennas. It is convenient to represent the latter one as

$$a {e}^{i ψ} = [ ( \frac{k}{c} m + [ k \times p ] ) \times k ] \frac{{e}^{ikr}}{4 π {ɛ}_{0} r} ,$$

so that the expression for the electric field assumes a compact form as in Equation 16, where α and ψ correspond to an amplitude and phase of the source.

E=e^{-ikr}^{₀}αe^{iψ} Equation 16

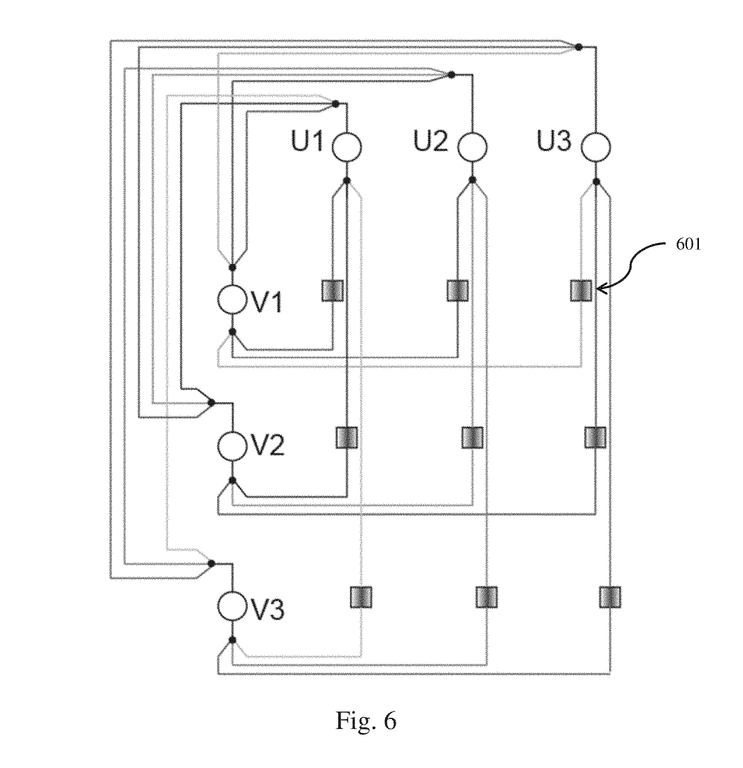

Referring to FIG. 6, a schematic illustration of an exemplary circuit layout. A perimeter control architecture for 3×3 array of elements 601 is shown. Shading denotes independent current loops. Points of common contact are shown as dots.

In exemplary architecture provided herein, it is assumed that signals applied at each row and column of the array are superimposed at a corresponding array element, Vᵥ=f(Vₗ+Uₙ); Vₗ and Uₙ denote control signals are control signals applied to respective column l and row n of the array, respectively. In case of a DC voltage controlled circuit such a scenario is realized with voltage sources connected in series. Each of the array elements sees only two of the required voltage sources connected in series.

In the schematic layout of FIG. 6, each of the array elements is fed by an independent circuit comprised of two respective voltage sources. The voltage drop across the element, by Kirchhoff's law is equal to the sum of voltages. Circuits with individual antenna elements are independent of each other.

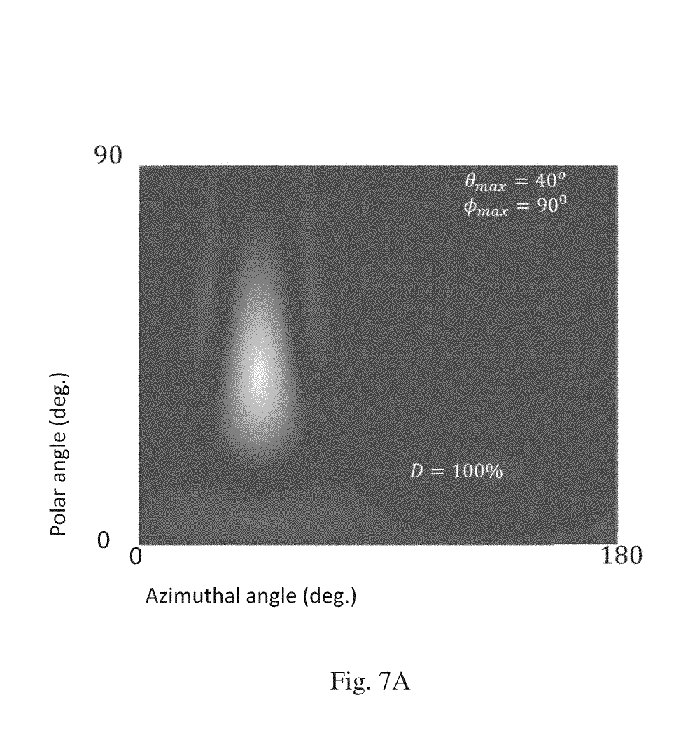

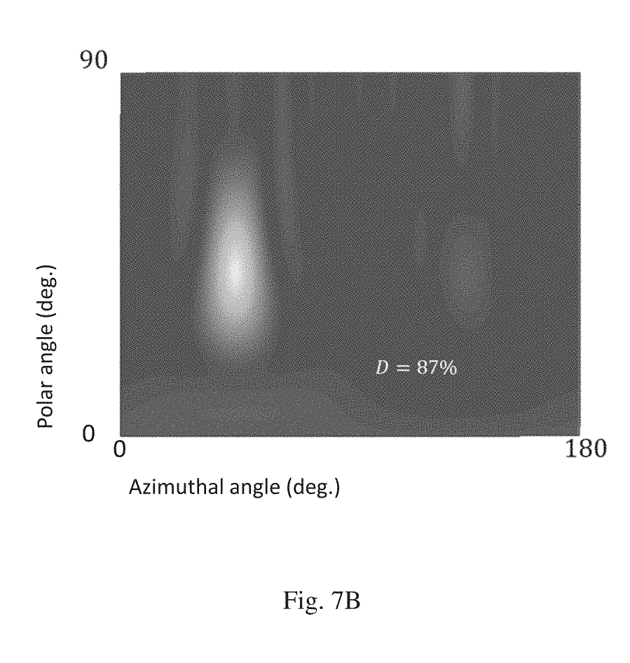

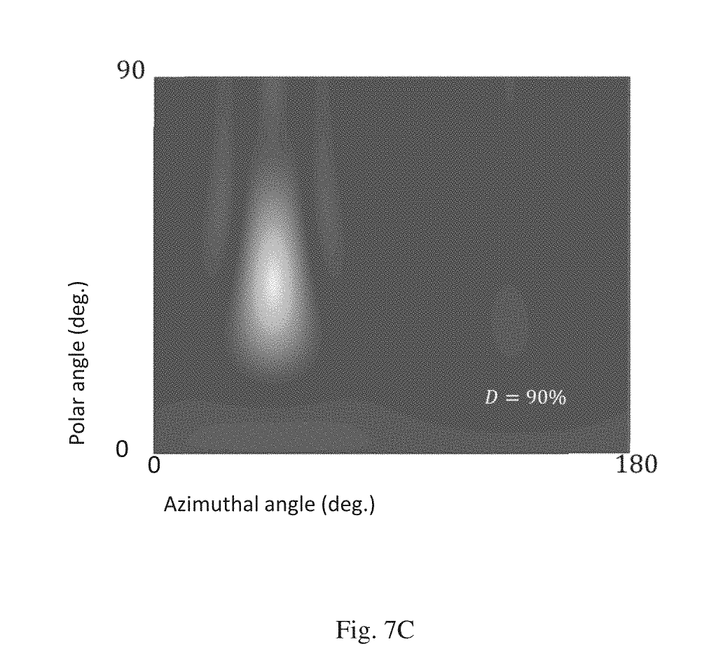

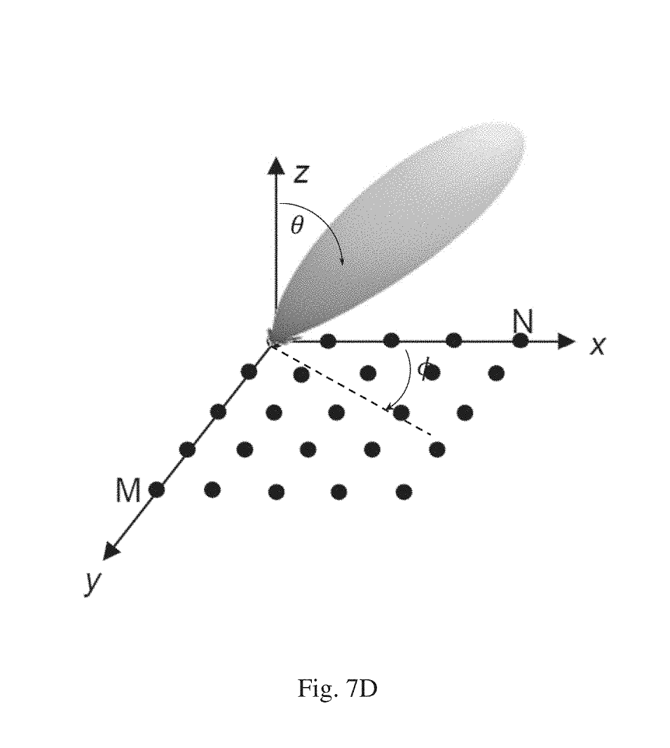

Referring now to FIG. 7, an example of beam steering by a non-uniform phased array with voltage-varying amplitude is illustrated. In this example, a 10×10 element array is used with a period of 400nm and a wavelength of 1525 nm. The amplitude and phase of each of the array elements depends on the voltage signal applied to it. The dependence is deduced from experimental data. FIG. 7A shows a target distribution. FIG. 7B shows an optimized distribution using an individual control architecture, resulting in array directivity of D=87%. FIG. 7C shows an optimized distribution using a perimeter control architecture, resulting in array directivity of D=90%. FIG. 7D shows a 3D representation of the target distribution.

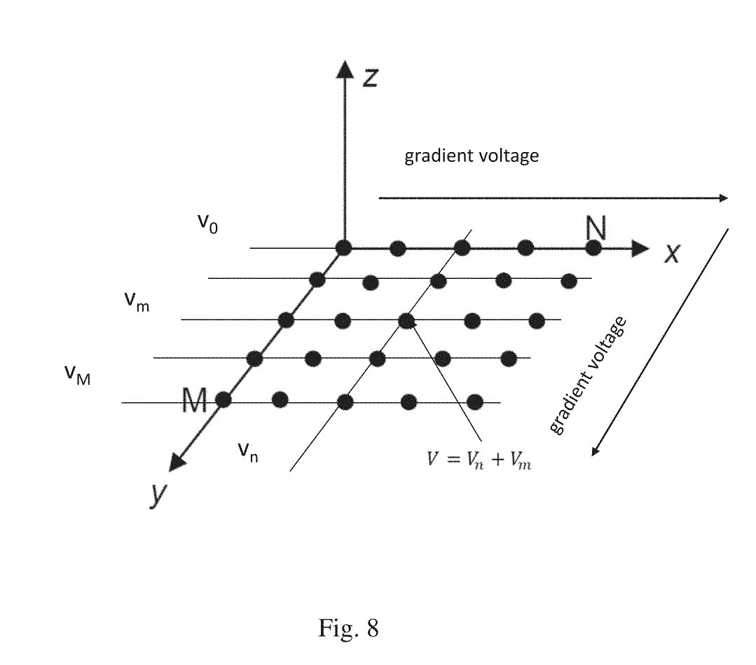

Referring now to FIG. 8, a schematic view of a perimeter control architecture is provided. For each element in the array, at row m and column n, V=Vₙ+Vₘ yielding the target gradient.

Although various embodiments above are described in terms of electromagnetic antennas or scatterers, it will be appreciated that the present disclosure is applicable to any array of coherent wave emitters. For example, the perimeter control architectures described herein may be applied to phased array acoustics, such as ultrasound. Beam steering with ultrasound phased arrays is of particular use for medical imaging and for wireless acoustic power transfer employed for charging multiple mobile devices. In such embodiments, an emitter may be a sound wave transmitter or transducer (e.g., ultrasound). More generally, the present disclosure is applicable to phased-array acoustics using a variety of emitters and metasurfaces.

The operation of such devices is analogous to electromagnetic arrays. In acoustic phased arrays the phase of the emitted wave at each of the each of the transducer elements is tuned by a signal controlled phase-shifter. Such a phase shift may be obtained by applying local physical forces such as temperature and electric field (e.g., by using to thermal expansion of materials or piezo electric effects).

Acoustic metasurfaces are artificial composite structures built by assembling a set of resonant elements, with each being much smaller than the working wavelength. Due to the subwavelength scale of an individual component, in the bulk metasurfaces behave like a continuous medium with unconventional acoustic bulk properties. The metasurface properties are in many ways equivalent to acoustic phased arrays, and hence the principles of beam steering employed in phased arrays is applicable to acoustic metasurface designs. By engineering the subwavelength microstructure of acoustic meta-atoms, it is possible to achieve effective acoustical parameters unattained with natural materials. Moreover, by applying external forces, the properties of each of the individual meta-atom elements may be tuned. By controlling the amplitude and phase of each of the meta-atoms, the scattering of the incident acoustic wave may be controlled at will. Applications include acoustic holograms and narrow beam forming for power transfer and imaging.

It will also be appreciated that while various embodiments above are concerned with emitters, the present disclosure is equally applicable to receivers, due to a fundamental principle of reciprocity. In particular, a phased array of receivers, such as electromagnetic antennas or ultrasound transducers may be controlled using the architectures set out herein. In this case, the direction of maximum sensitivity to an incoming wave may be tuned by employing architectures set out herein.

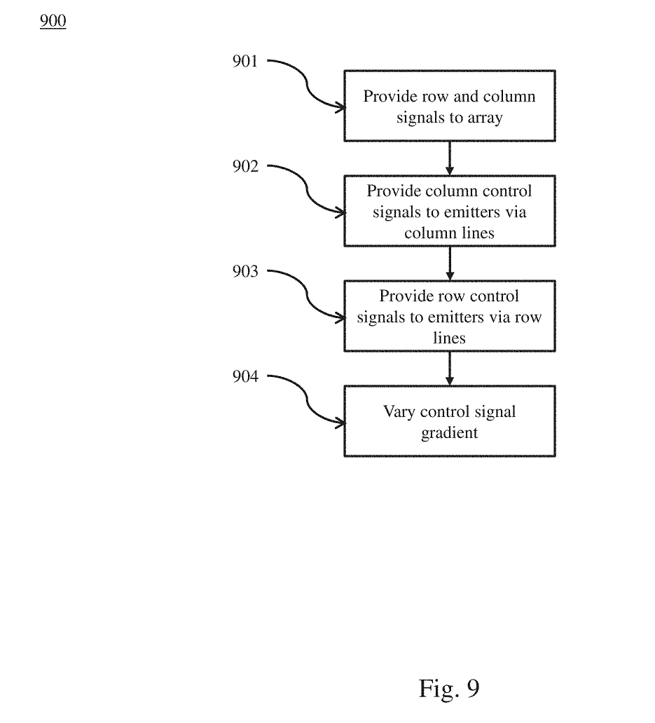

Referring now to FIG. 9, a method of beam steering is illustrated according to embodiments of the present disclosure. At 901, a plurality of row signals and a plurality of column signals are provided to an array of waveform emitters. The array has a plurality of rows and a plurality of columns, each of the emitters being disposed within one of the plurality of rows and one of the plurality of columns. At 902, column control signals are provided to the plurality of waveform emitters via a plurality of column control lines, each column control line interconnecting the emitters within one of the plurality of columns. At 903, row control signals are applied to the plurality of waveform emitters via a plurality of row control lines, each row control line interconnecting the emitters within one of the plurality of rows. At 904, the phase of each of the plurality of waveform emitters is varied by varying a control signal gradient along the row control lines and column control lines, the plurality of waveform emitters remaining coherent.

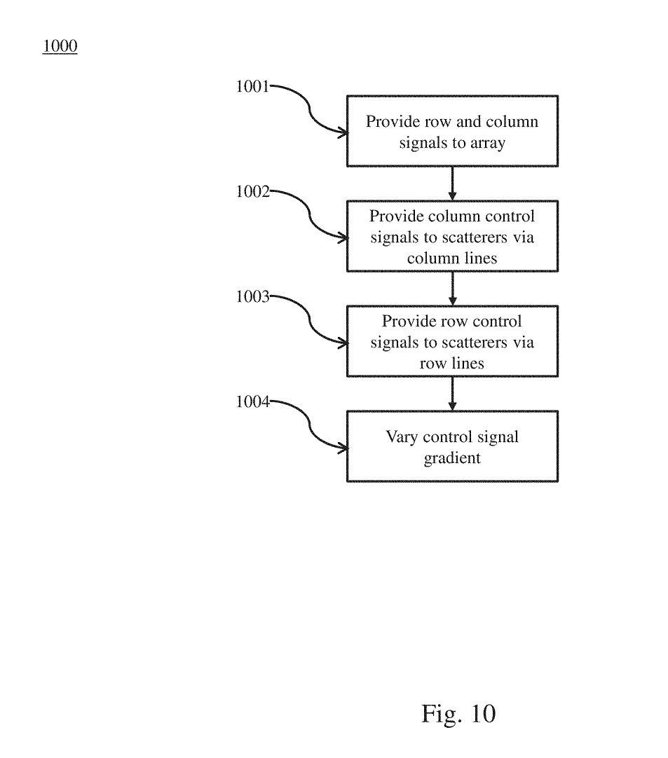

Referring now to FIG. 10, a method of holographic image projection is illustrated according to embodiments of the present disclosure. At 1001, a plurality of row signals and a plurality of column signals are provided to an array of scatterers. The array has a plurality of rows and a plurality of columns, each of the scatterers being disposed within one of the plurality of rows and one of the plurality of columns. At 1002, column control signals are provided to the plurality of scatterers via a plurality of column control lines, each column control line interconnecting the scatterers within one of the plurality of columns. At 1003, row control signals are provided to the plurality of scatterers via a plurality of row control lines, each row control line interconnecting the scatterers within one of the plurality of rows. At 1004, the array is exposed to an incident electromagnetic plane wave. At 1005, the incident wave is modulated by varying a control signal gradient along the row control lines and column control lines, while maintaining coherence.

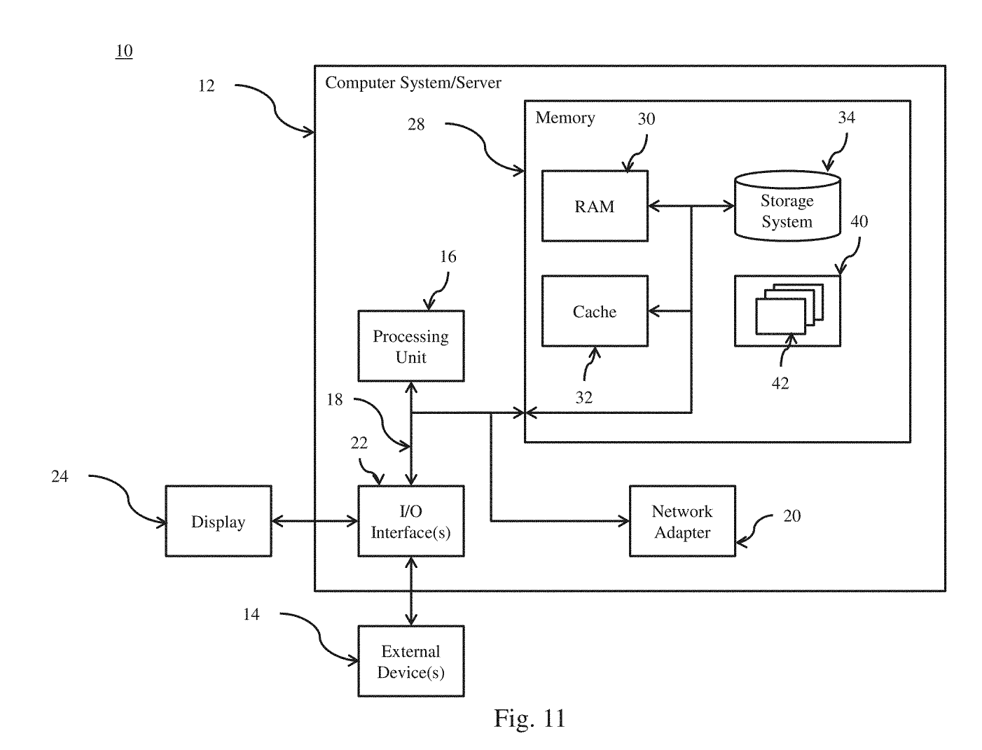

Referring now to FIG. 11, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 11, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

In various embodiments, a phased array may be coupled to I/O interface(s) 22 to enable control of the phased array as described herein by a computing node. Likewise, in various embodiments, a sensor network may be coupled via I/O interface(s) 22 to provide sensor input to a computing node.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device comprising:
a plurality of waveform emitters disposed in an array having a plurality of rows and a plurality of columns, each of the emitters being disposed within one of the plurality of rows and one of the plurality of columns;
a plurality of column control lines, each column control line interconnecting the emitters within one of the plurality of columns and adapted to provide a column control signal to the emitters within that column;
a plurality of row control lines, each row control line interconnecting the emitters within one of the plurality of rows and adapted to provide a row signal to the emitters within that row, wherein
a phase of each of the plurality of waveform emitters varies with the column control signal and the row control signal provided to that emitter, the plurality of waveform emitters remaining coherent.

2. The device of claim 1, wherein each of the plurality of waveform emitters comprises an electromagnetic emitter.

3. The device of claim 1, where each of the plurality of waveform emitters comprises an electromagnetic antenna.

4. The device of claim 1, wherein each of the plurality of waveform emitters comprises an electromagnetic scatterer.

5. The device of claim 1, wherein each of the plurality of waveform emitters comprises an acoustic transducer.

6. The device of claim 1, wherein the rows are orthogonal to the columns.

7. The device of claim 1, wherein the emitters are evenly spaced within each of the plurality of rows.

8. The device of claim 1, wherein the emitters are evening spaced within each of the plurality of columns.

9. The device of claim 1, wherein the array defines a two-dimensional surface.

10. The device of claim 1, wherein the array is planar.

11. The device of claim 1, wherein each column control signal comprises an applied voltage and each row control signal comprises an applied voltage.

12. The device of claim 1, wherein each column control signal comprises a magnetic field and each row control signal comprises a magnetic field.

13. The device of claim 1, wherein each column control signal comprises an electromagnetic field and each row control signal comprises an electromagnetic field.

14. The device of claim 1, wherein each column control signal comprises an applied temperature field and each row control signal comprises an applied temperature.

15. The device of claim 1, wherein a phase of each of the plurality of waveform emitters varies with a sum of the column control signal and the row control signal provided to that emitter.

16. The device of claim 1, further comprising a computing node operatively coupled to the column control lines and the row control lines and adapted to provide column control signals to the column control lines and row control signals to the row control lines.

17. A device comprising:
a plurality of waveform detectors disposed in an array having a plurality of rows and a plurality of columns, each of the detectors being disposed within one of the plurality of rows and one of the plurality of columns;
a plurality of column control lines, each column control line interconnecting the detectors within one of the plurality of columns and adapted to provide a column control signal to the detectors within that column;
a plurality of row control lines, each row control line interconnecting the detectors within one of the plurality of rows and adapted to provide a row signal to the detectors within that row, wherein
a phase of each of the plurality of waveform detectors varies with the column control signal and the row control signal provided to that detectors, the plurality of waveform detectors remaining coherent.

18. A method of beam steering, the method comprising:
providing a plurality of row signals and a plurality of column signals to an array of waveform emitters,
the array having a plurality of rows and a plurality of columns, each of the emitters being disposed within one of the plurality of rows and one of the plurality of columns;
providing column control signals to the plurality of waveform emitters via a plurality of column control lines, each column control line interconnecting the emitters within one of the plurality of columns;
providing row control signals to the plurality of waveform emitters via a plurality of row control lines, each row control line interconnecting the emitters within one of the plurality of rows;
varying the phase of each of the plurality of waveform emitters by varying a control signal gradient along the row control lines and column control lines, the plurality of waveform emitters remaining coherent.

19. A method of holographic image projection, comprising:
providing a plurality of row signals and a plurality of column signals to an array of scatterers,
the array having a plurality of rows and a plurality of columns, each of the scatterers being disposed within one of the plurality of rows and one of the plurality of columns;
providing column control signals to the plurality of scatterers via a plurality of column control lines, each column control line interconnecting the scatterers within one of the plurality of columns;
providing row control signals to the plurality of scatterers via a plurality of row control lines, each row control line interconnecting the scatterers within one of the plurality of rows;
exposing the array to an incident electromagnetic plane wave;
modulating the incident wave by varying a control signal gradient along the row control lines and column control lines, while maintaining coherence.

20. The method of claim 12, further comprising:
decomposing an image into a set of separable matrices;
varying the voltage gradient along the row control lines and column control lines over time according to each of the set of separable matrices.
